(19) United States
(12) Patent Application Publication
(10) Pub. No.: US 2022/0152966 A1
(43) Pub. Date: May 19, 2022

(54) MULTI-ANVIL HIGH PRESSURE PRESS AND RELATED METHODS

(71) Applicant: US Synthetic Corporation, Orem, UT (US)

(72) Inventors: Derek M. Lontine, Spanish Fork, UT (US); Joshua J. Nell, Tooele, UT (US); Dean R. Simmonds, Lehi, UT (US)

(21) Appl. No.: 16/144,541

(22) Filed: Sep. 27, 2018

Related U.S. Application Data
(60) Provisional application No. 62/564,691, filed on Sep. 28, 2017.

(51) Int. Cl. B30B 11/00; B30B 11/04; B30B 15/34

(52) U.S. Cl. CPC B30B 11/004; B30B 15/34; B30B 11/04

(57) ABSTRACT

A high-temperature, high-pressure (HTHP) press is provided having a plurality of press bases. In one embodiment, the press includes eight or more press bases arranged in one of an octahedral, a dodecahedral or an icosahedral geometry. The press bases may include, or be coupled with, anvils configured to converge on a central region. An octahedral, a dodecahedral or an icosahedral reaction cell may be positioned at the central region for pressing by the converging anvils. In one embodiment, the reaction cell may include an opening, such as a through-hole, extending from a first face of the reaction cell to a second, opposite face of the reaction cell. One or more canisters containing materials to be sintered may be disposed in the opening to be subjected to a HTHP process.

### BACKGROUND

High pressure presses have been used for decades in the manufacture of synthetic diamond. Such presses are capable of exerting high pressures on a volume of carbonaceous or other material at high temperatures to create conditions for sintering polycrystalline diamond. Known designs for high pressure presses include, but are not limited to, the belt press, the tetrahedral press, and cubic presses.

As an example, a cubic press generally includes six press bases, with each press base facing towards a common central region. Each press base houses a piston which is capable of being displaced towards the central region. Tie bars or other structural members may extend between and be coupled to individual press bases to form a structural framework that supports the press bases during operation of the press.

The cubic press conventionally includes a plurality of anvils, with each anvil being coupled to an associated one of the pistons. The anvils each include an engagement surface which may be aligned perpendicularly to the axis of motion of the piston. The engagement surfaces of the anvils are configured to collectively converge upon a cube-shaped volume disposed about the central region or location. During operation of the press, this volume may be occupied with a generally cube-shaped reaction cell containing materials that are, for example, to be converted or sintered to polycrystalline diamond. During such an operation, the engagement surfaces apply both pressure and energy to the reaction cell to create the necessary conditions within the reaction cell for forming synthetic diamond.

An example of the process that takes place in forming polycrystalline diamond under HTHP conditions is described in U.S. Pat. No. 3,745,623 to Wentorf, Jr. et al., the disclosure of which is incorporated by reference herein. Examples of cubic presses and related components used in HTHP processes may be found in U.S. Pat. No. 8,910,568 issued on Dec. 16, 2014, U.S. Pat. No. 8,739,697 issued on Jun. 3, 2014, U.S. Pat. No. 8,850,971 issued on Oct. 7, 2014, U.S. patent application Ser. No. 8,857,328 issued on Oct. 14, 2014, and U.S. Pat. No. 8,851,871 issued Oct. 7, 2014, the disclosures of which are incorporated by reference herein in their entireties.

Various components of conventional HTHP presses are subject to failure due to the significant loads and stresses experienced during the HTHP process. Additionally, the magnitude of the pressure that may be applied to a reaction cell is sometimes limited due to the to design of such presses. Furthermore, depending on the specific design of the press, HTHP presses do not always apply pressure to the reaction cell equally on all sides of a reaction cell. Thus, the product being formed using the HTHP may not re ve appropriate pressure throughout the body of the reaction cell Sometimes this results in an application of elevated pressures and/or temperatures to ensure that a minimum pressure or temperature is achieved throughout a reaction cell.

It is a continual desire in the industry to provide presses and related processes that will enable more evenly distributed pressure to a reaction cell, enable the processing of products at lower pressures when possible, and improve the safety, durability and longevity of the apparatuses used in HTHP processes.

### SUMMARY

The present disclosure provides embodiments of high-temperature, high-pressure (HTHP) presses, reaction cells for use in HTHP presses, and related methods. In accordance with one embodiment of the disclosure an HTHP press includes eight or more press bases arranged in one of an octahedral, a dodecahedral or an icosahedral geometry.

In accordance with one embodiment, each press base includes a body portion housing a piston, the piston being displaceable toward a central region of the press.

In accordance with one embodiment, each press includes an anvil coupled with the piston.

In accordance with one embodiment, each anvil includes a substantially planar engagement surface having one of a triangular, a rectangular or a pentagonal shaped periphery.

In accordance with one embodiment, at least two of the anvils are coupled with a source of electrical energy.

In accordance with one embodiment, the at least two anvils are arranged to be opposite each other across the central region.

In accordance with one embodiment, the HTHP press further comprises a plurality of tie bars, wherein each tie bar extends between, and is coupled to, a pair of adjacent bases.

In accordance with one embodiment, the HTHP press further comprises a dodecahedral reaction cell disposed in a central region of the press, wherein each of the anvils is in contact with a separate face of the reaction cell.

In accordance with one embodiment, the reaction includes a through hole extending from a first face of the reaction cell to a second, opposing face of the reaction cell.

In accordance with one embodiment, the reaction cell includes a heating element and at least one canister containing a sinterable material.

In accordance with one embodiment, the reaction cell comprises two mating halves assembled together.

In accordance with another embodiment of the present disclosure, a reaction cell for use in a high-temperature, high pressure (HTHP) press is provided. The reaction cell comprises a body exhibiting one of an octahedral, a dodecahedral or an icosahedral geometry, the body including a through hole extending from a first face to a second, opposing face of the body.

In accordance with one embodiment, the body comprises a pyrophyllite material.

In accordance with one embodiment, the body is formed of two discrete halves.

In accordance with one embodiment, the reaction cell further comprises at least one canister disposed within the through-hole, the at least one canister containing a sinterable material.

In accordance with one embodiment, the reaction cell further comprises a heating element disposed within the through-hole and adjacent the at least one canister.

In accordance with one embodiment, the heating element comprises graphite.

In accordance with one embodiment, the reaction cell further comprises at least one conductive ring disposed in the through-hole.

In accordance with one embodiment, the reaction cell further comprises at least one conductive disc disposed in the through-hole, wherein the at least one conductive disc is in contact with the at least one conductive ring and with the heating element.

In accordance with one embodiment, the at least one conductive ring is in contact with the heating element.

In accordance with one embodiment, the through hole includes first section exhibiting a first diameter and a second section exhibiting a second diameter.

In accordance with another embodiment of the disclosure, high-pressure, high-temperature (HTHP) press comprising a plurality of anvils, wherein each anvil includes an engagement surface and a side surface. Each anvil is displaceable along an associated centerline relative to a center region associated with an intersection of the centerlines, wherein, when two adjacent anvils of the plurality of anvils are displaced along their associated centerlines at a rate of \dot{x}, the side surfaces of each of the two adjacent anvils are displaced towards each other at a rate of ġ, and wherein the ratio of ġ/\dot{x} is less than 0.7.

In accordance with one embodiment, the ratio of ġ/\dot{x} is approximately 0.577 or less.

In accordance with one embodiment, the ratio of ġ/\dot{x} is approximately 0.525 or less.

In accordance with one embodiment, the ratio of ġ/\dot{x} is approximately 0.357 or less.

In accordance with one embodiment, the press further comprises a plurality of bases, each base being associated with one of the plurality of anvils and configured to displace the associated anvil along its associated centerline.

In accordance with one embodiment, the plurality of anvils includes at least 8 anvils arranged in an octahedral geometry.

In accordance with one embodiment, the plurality of anvils includes at least 12 anvils arranged in an dodecahedral geometry.

In accordance with one embodiment, plurality of anvils includes at least 20 anvils arranged in an icosahedral geometry.

Any feature, element or aspect of any embodiment described herein may be combined with any feature, element or aspect of any other embodiment described herein, without limitation.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is a side view of a dodecahedral press according to an embodiment of the present disclosure;

FIG. 2 is a partial cross-sectional side view of the press shown in FIG. 1;

FIG. 3 is an enlarged detail view of a portion of the press shown in FIG. 2;

FIG. 4 illustrates a plurality of anvils in a dodecahedral arrangement as may be used in conjunction with the press shown in FIG. 1;

FIG. 5 is an exploded view of the anvils shown in FIG. 4 along with a dodecahedral reaction cell;

FIG. 6 is a perspective view showing six of twelve anvils while in a dodecahedral arrangement;

FIG. 7 is a top view of the arrangement shown in FIG. 6;

FIG. 8 is a cross-sectional view of the arrangement shown in FIG. 4;

FIG. 9 shows an arrangement of two adjacent anvils of a press according to an embodiment of the present disclosure;

FIG. 10 is a cross-sectional view of a dodecahedral reaction cell according to an embodiment of the present disclosure; and

FIG. 11 is a cross-sectional view of a dodecahedral reaction cell according to another embodiment of the present disclosure.

### DETAILED DESCRIPTION

Embodiments of a multi-anvil press and related methods are described herein. For example, in accordance with one embodiment of the disclosure, a dodecahedral press is provided which is configured to apply pressure to the sides of a reaction cell configured as a dodecahedron during a high-pressure, high-temperature (HPHT) process. For purposes of this disclosure, a dodecahedron is a polyhedron having twelve flat faces and may include the platonic solid known as a regular dodecahedron. The term “dodecahedral” as used herein denotes a shape or configuration that is associated with a dodecahedron including, for example, a press having a plurality of bases that are configured to apply pressure to all sides of a reaction cell configured as a dodecahedron. Other press configurations are also contemplated, including octahedral presses (e.g., presses having eight anvils configured to press against a reactional cell configured as an octahedron) and icosahedral presses (e.g., presses having 20 anvils configured to press against a reaction cell configured as an icosahedron).

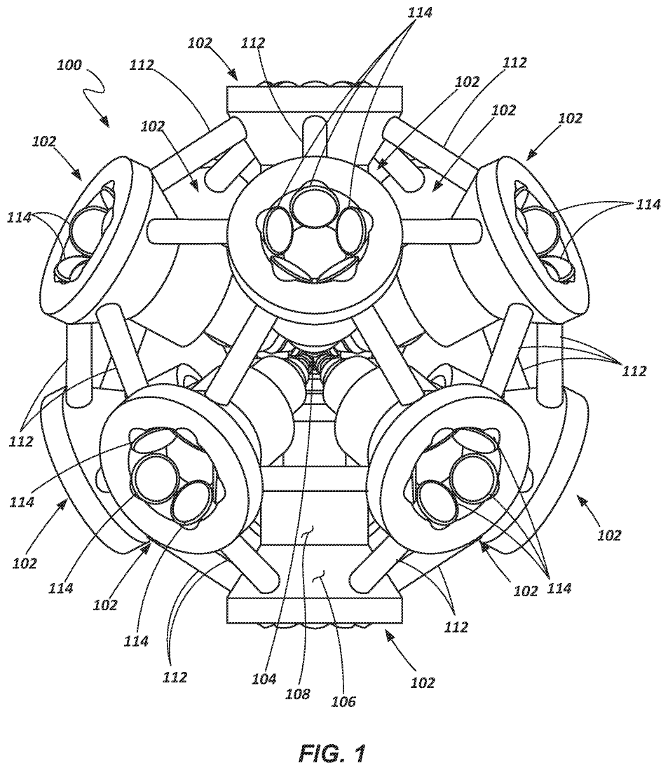

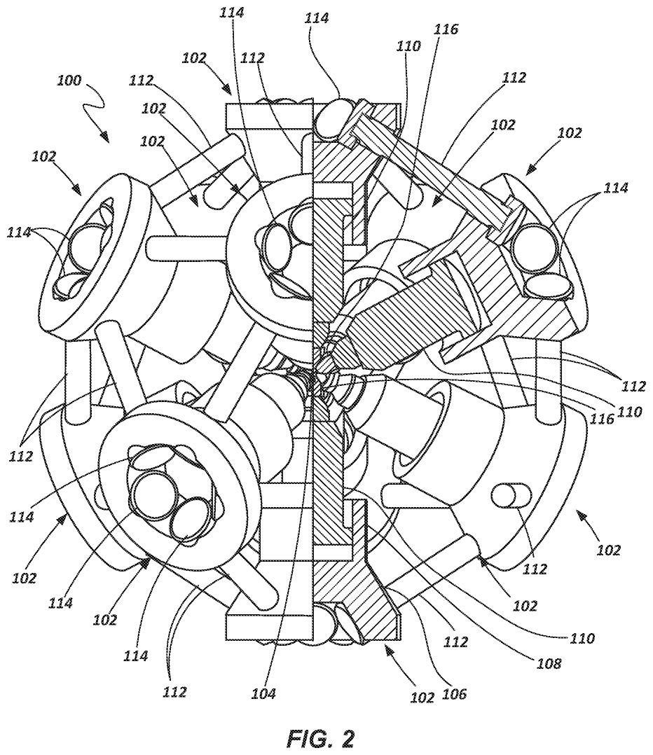

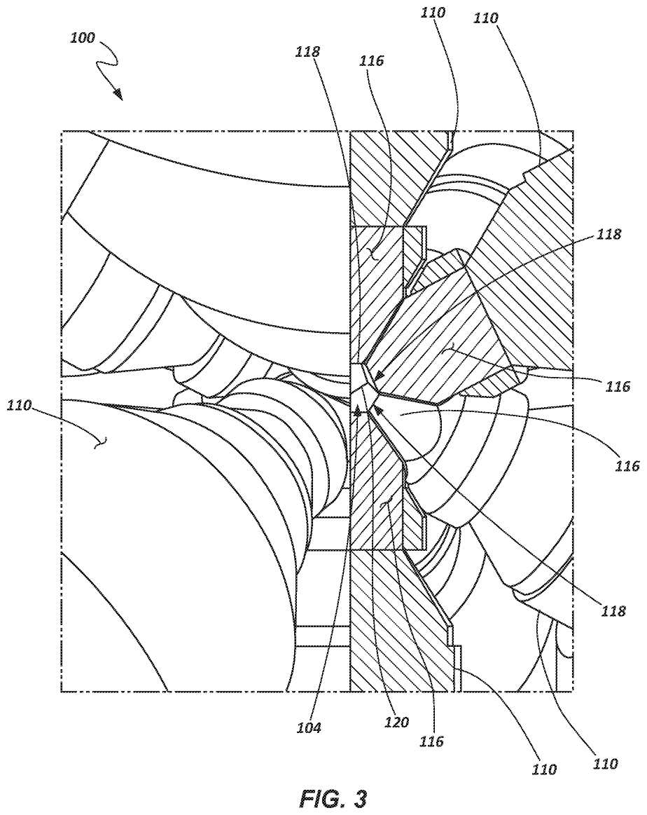

Referring to FIGS. 1-3, a multi-anvil press 100 is shown in accordance with one embodiment of the present disclosure. The example press 100 is configured as a dodecahedral press having twelve press bases 102 with each press base 102 facing generally towards a common central region 104. In one embodiment, each press base 102 may each include a generally conical body portion 106 and a second outer body portion 108 which houses a piston 110. The pistons are each configured for displacement relative to their associated press base 102 generally towards and away from the central region 104. Tie bars 112 or other structural members may extend between and be coupled to individual press bases 102 by way of a coupling member 114 (e.g., a nut or other appropriate coupling device) to form a structural framework that supports the press bases 102 during operation of the press 100.

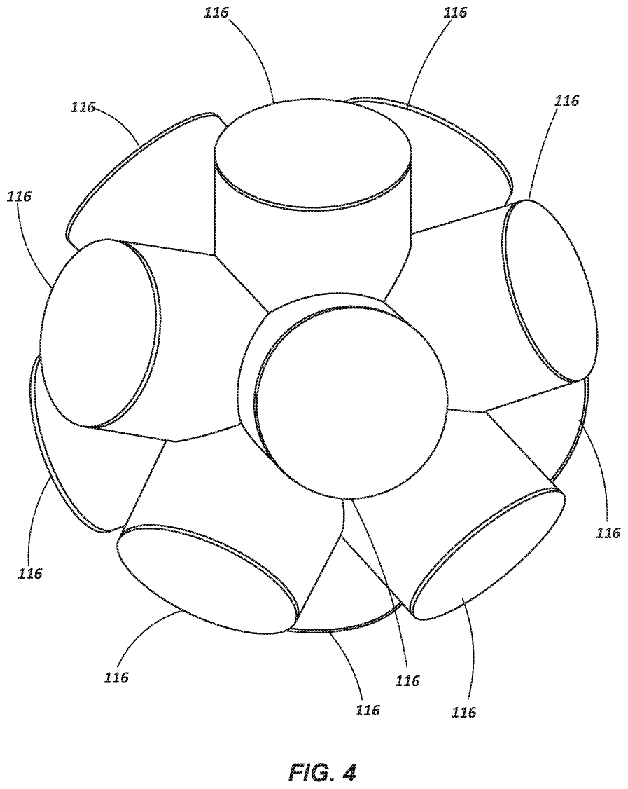

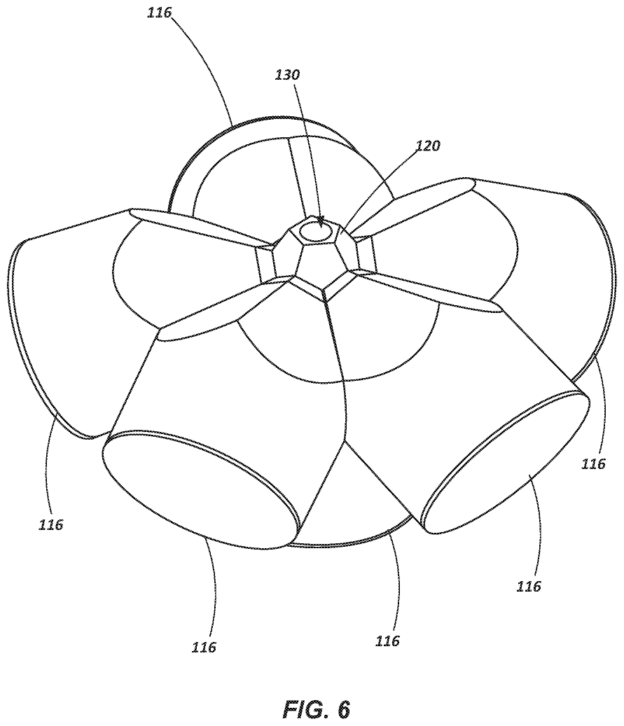

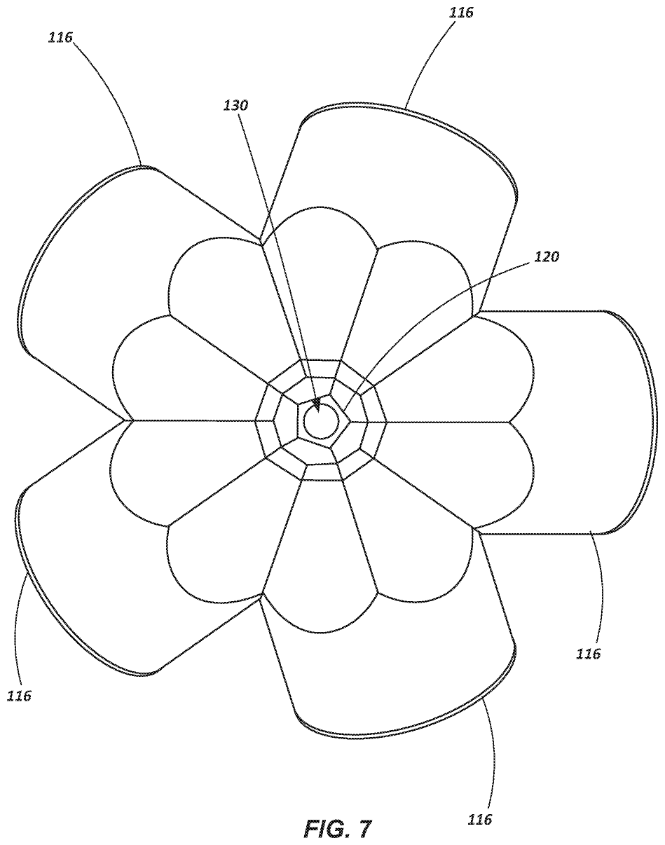

The press 100 additionally includes a plurality of anvils 116, with each anvil 116 being coupled to an associated one of the pistons 110. As seen in FIGS. 4-7 in conjunction with FIGS. 1-3, the anvils 116 each include an engagement surface 118 which may be aligned perpendicularly to the axis of motion of the piston 110. The faces or engagement surfaces 118 of the anvils 116 are configured to collectively converge upon the central region or location 104. During operation of the press 100, this volume may be occupied with a generally dodecahedral-shaped reaction cell 120 containing materials that are, for example, to be converted or sintered to polycrystalline diamond. During such an operation, the engagement surfaces 118 apply pressure and provide energy (e.g., heat and/or electrical energy) to the reaction cell to create the necessary conditions within the reaction cell 120 for forming a sintered product such as synthetic diamond. It is noted that, while the press 100 (and related components) illustrated in FIGS. 1-3 depict a dodecahedral press, other press configurations are also contemplated and would include a different number of bases, pistons, anvils and so forth. For example, an octahedral press would include eight bases with related components configured to apply pressure to a reaction cell configured as an octahedron. Similarly, an icosahedral press would include twenty bases with related components configured to apply pressure to a reaction cell configured as an icosahedron.

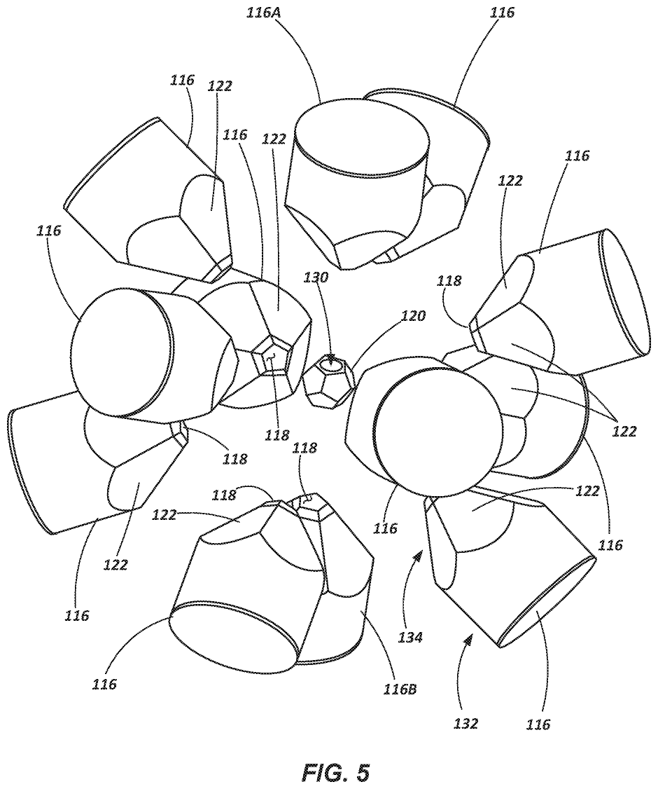

As perhaps best seen in FIG. 5, each of the engagement surfaces 118 is configured as a planar surface exhibiting a pentagonal geometry and may be complimentary to one of the pentagonal side surfaces of the dodecahedral reaction cell 120. The reaction cell 120 may include an opening 130 formed therein for receipt of one or more cans or canisters containing materials to be converted into, for example, polycrystalline diamond compacts, which may be used in a variety of applications. It is noted that a reaction cell used with a dodecahedral press need not have faces that exhibit pentagonal geometries (e.g., the geometry associated with a regular dodecahedron). Thus, in other embodiments, the engagement surfaces 118 may exhibit other geometries including, for example, triangular, rectangular or hexagonal geometries.

FIG. 5 shows the anvils 116 in a retracted state (e.g., prior to converging toward the reaction cell 120 located at the central region 104). It is noted that the anvils 116 may include a first portion 132 which is substantially cylindrical and a second, converging or tapered section 134 which, as shown, may include five generally planar sides which converge to the engagement surface 118. In one embodiment, one or more of the anvils may be electrically coupled with a source of electrical energy (e.g., a current source) to provide electrical energy to the reaction cell 120 during pressure, the electrical energy causing the temperature to rise within the reaction cell 120 to a desired processing temperature. In one particular embodiment, two opposing anvils (e.g., 116A and 116B) may be coupled with a source of electrical energy and configured to provide electrical energy to the reaction cell 120. It is noted that in other embodiments, energy may be supplied to reaction cell 120 by other processes or mechanisms including, for example, induction heating or application of microwave energy.

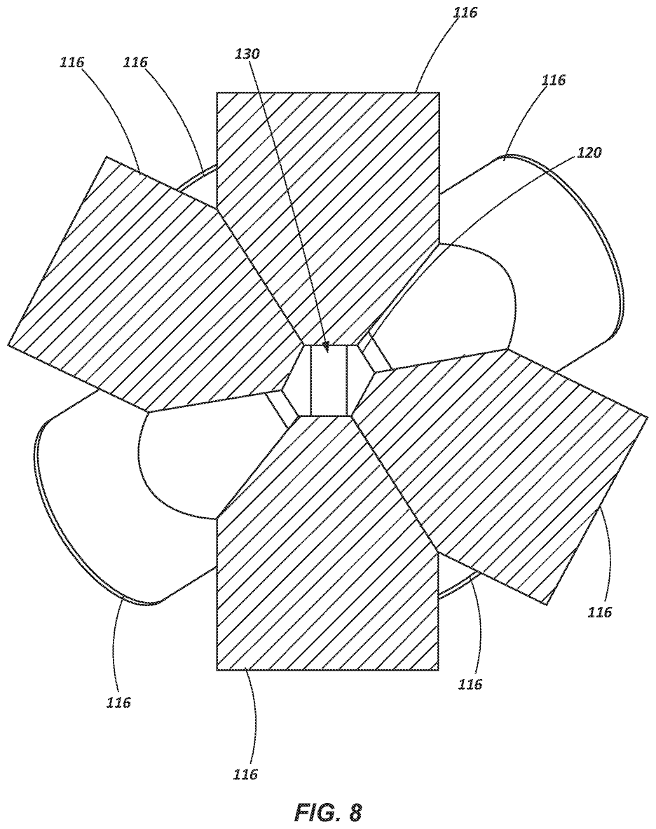

As seen in FIGS. 4 and 6-8, when the anvils 116 are displaced toward the central region 104 the planar side surfaces 122 of a given anvil also approach the planar side surfaces 122 of adjacent anvils. In one embodiment, the anvils 116 may be designed such that when the engagement surfaces have compressed the reaction cell to a desired level, the planar sides of the converging section of the anvils 116 may be substantially evenly spaced from planar surfaces of adjacent anvils 116, fitting the anvils 116 together in a geometric arrangement that enables pressure to be applied to each face of the reaction cell in a substantially even or uniform manner. In another embodiment, when the engagement surfaces 118 have converged to a desired position (e.g., applying a desired level of pressure to the reaction cell 120), differently sized gaps exist between side surfaces 122 of a given anvil 116 and side surfaces 122 of adjacent anvils 116.

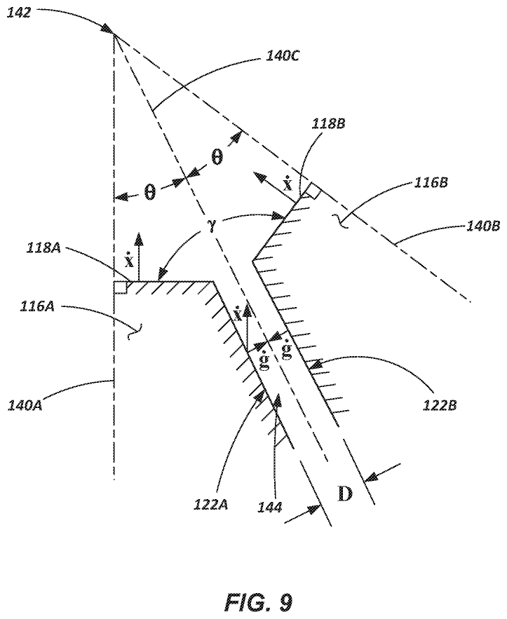

Referring to FIG. 9, a schematic depicts an arrangement of two adjacent anvils 116A and 116B according to an embodiment of the present disclosure. In the arrangement depicted in FIG. 9, the angle y represents the dihedral angle formed by engagement surfaces 118A and 118B of the adjacent anvils 116A and 116B. The angle θ represents the angle between an anvil centerline (e.g., centerline 140A or 140B) and a centerline 140C that extends between the side surfaces 122A and 122B of the adjacent anvils 116A and 116B. Geometrically, these angles are related to each other by the following equation:

θ=90°−(γ/2)

Each of the anvils 116A and 116B are displaceable along their associated centerlines 140A and 140B to either converge towards, or be displaced away from, a geometric center point 142. As the engagement surfaces 118A and 118B of the anvils 116A and 116B are displaced relative to the center point 142 at a rate of \dot{x}, side surfaces 122A and 122B (which may be generally parallel to one another) are each displaced relative to one another at a rate of ġ, altering the distance D, or the “gasket gap” between the two anvils 118A and 118B. Thus, if both anvils 116A and 116B are being displaced concurrently at a rate of \dot{x}, the distance D between adjacent anvils will change at a rate of 2 ġ. Given the geometry shown in FIG. 9, the displacement rate ġ of the side surfaces 122A and 122B may be determined according to the following equation:

ġ=\dot{x}·sin θ EQ. 2

The ratio of ġ/\dot{x}, which may be referred to as the gasket-body approach ratio and is related to the forces experienced by the reaction cell 120. For example, during application of pressure to a reaction cell 120 by the anvils of a press, gasket material may be pressed such that it is displaced into the gap between adjacent anvils (e.g., in the inter-anvil gap 144 in FIG. 9 indicated by width D between side surfaces 122A and 122B). The gasket material that is pressed into this gap 144 experiences a loading that is different from the gasket material of the reaction cell within the volume defined by the engagement surfaces (e.g., 118A and 118B) of the anvils. The uneven or differential loading of the gasket material can have deleterious effects on the process, possibly even leading to failure of one or more of the anvils and/or of the reaction cell itself. For example, in a cubic press (a press having six anvils converging towards a geometric center), the gasket-body approach ratio is about 0.707. Since two adjacent anvils are moving towards each other simultaneously (i.e., 2 ġ needs to be accounted for), the rate of change of width D of the gap between adjacent anvils compared to their advancement toward the geometric center 142 (i.e., D/\dot{x}) is about 1.414, meaning that any gasket material within the inter-anvil gap will see forces applied at a significantly greater rate than gasket material located within the volume defined by the engagement surfaces of the anvils. The reverse is also true when the anvils are retracting away from the geometric center 142. Thus, the side surfaces 122 of the anvils 116 see significantly different loading characteristics as compared to the engagement surfaces 118 of the anvils 116, creating stress profiles that may lead to fatigue and premature failure of the anvils. A reduction in the gasket-body approach ratio, therefore, may provide an improved stress profile within the anvils 116 and may reduce the risk of failure within the system. Table 1 set forth below provides some non-limiting examples of configurations that provide a reduced gasket-body approach ratio (as compared to a cubic press configuration). It is noted that N in Table 1 represents the number of anvil faces or engagement surfaces (e.g., 118) of the stated press type.

TABLE 1

| Press Type | γ | θ | ġ/\dot{x} | N |
|---|---|---|---|---|
| Cube | 90° | 45° | 0.707 | 6 |
| Octahedron | 109.5° | 32.25° | 0.577 | 8 |
| Dodecahedron | 116.6° | 31.7° | 0.525 | 12 |
| Icosahedron | 138.2° | 20.9° | 0.357 | 20 |

Thus, the presses of the present disclosure, including octahedral, dodecahedral and icosahedral arrangements of anvils 116 and associated reaction cells 120, enable the side surfaces 122 of a given anvil 116 (which, in some embodiments, may be configured as planar side surfaces) to approach or withdraw from side surfaces 122 of adjacent anvils 116 at a rate such that the gasket-body approach ratio ġ/\dot{x} is reduced in comparison to prior art presses, including cubic presses. The reduced gasket-body approach ratio (regardless of whether the anvils are being displaced towards a geometric center 142 or withdrawing from the center 142) results in desirable forces being present in the portion of the gasket disposed within the gap 144 during operation of the press. This arrangement is advantageous to help prevent or reduce the incidence of failures and attendant damage to the anvils 116. Decompression failures are believed to be caused, at least in part, by the hysteresis experienced by gasket material during unloading (e.g., reducing or removing pressure from the reaction cell 120) where the gaskets can slip if pressure is relieved too quickly.

It is also noted that presses of the present disclosure, including dodecahedral presses, may enable higher pressures to be applied to the reaction cell 120 as compared to, for example, a cubic press, while maintaining the same, or even lower operating stresses in the anvils, forces of pistons, as well as lower gasket pressures, as compared to the same cubic press.

The press 100 may include numerous variations, including, for example, the employment of one or more of the spacer and tie-bar embodiments such as described in U.S. Pat. No. 8,857,328, issued Oct. 14, 2014, previously incorporated by reference, or any other feature or features of the previously incorporated references. The dodecahedral arrangement may also be implemented into so-called hinge-pin press designs and into designs utilizing a central block or body with twelve cartridges symmetrically surrounding and coupled with the central block.

It is further noted that the configuration of a dodecahedral press, such as shown in the drawing figures and described herein (as well as other embodiments of presses discussed in the present disclosure), provides a press wherein each anvil is the same shape and size, resulting in interchangeability and fewer types of parts. Additionally, the dodecahedral arrangement results in the forces present in each piston being substantially equal, again simplifying the design of the press and enabling a common cylinder/piston design to be used for each of the twelve cylinder/piston combinations. Another advantage of the dodecahedral design includes the connection forces between press bases being the second lowest of platonic solids, again providing significant advantages regarding the design individual components for purposes of strength, stress and fatigue.

As seen in FIG. 5-8, and as noted above, the reaction cell 120 may include an opening 130 or a bore formed therein for receipt of one or more cans or canisters containing materials that are to be subjected to a HTHP process. The opening 130 may include a straight through-bore extending from one face of the dodecahedral reaction cell 120 to an opposing face of the dodecahedral reaction cell 120. The body of the reaction cell 120 may be formed of, for example, a gasket material and the bore may contain one or more salt component, conductive element, heater, insulator, and one or more cans or canisters as will be described in further examples below. The use of a dodecahedral reaction cell 120, due to its geometry and the associated arrangement of the press 100, may provide improved thermal insulation for the anvils 116, keeping the anvils 116 at a reduced temperature as compared to prior art presses, thus extending the life of the anvils 116.

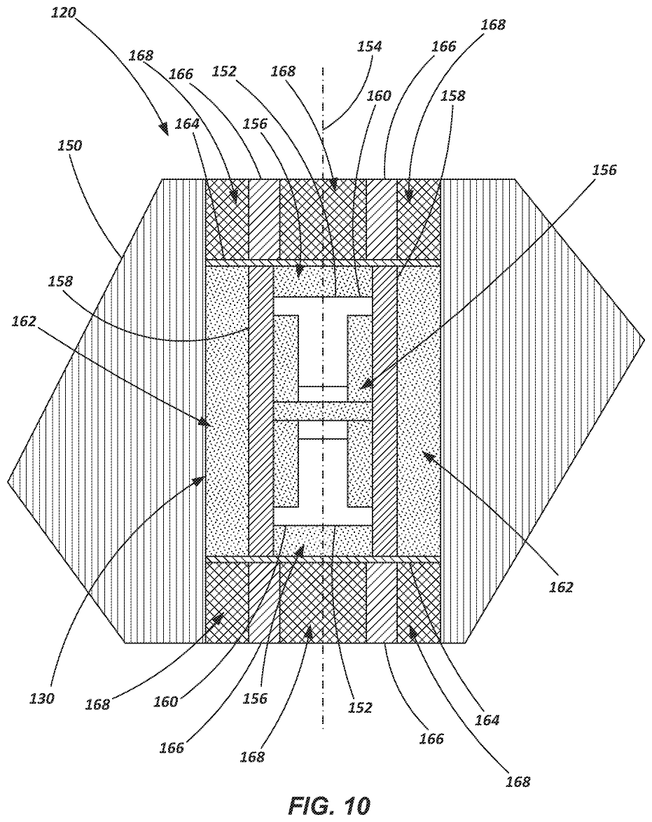

Referring to FIG. 10, one embodiment of a reaction cell 120 is shown and described. The reaction cell 120 may include a body 150, sometimes referred to as the cell pressure media (CPM) which may be formed, for example, of a pyrophyllite or synthetic gasket material. In one particular embodiment, the CPM material may include talc and garnet with sodium silicate as a binder. In certain embodiments, CPM materials may be formed in accordance with the examples set forth in U.S. Pat. No. 6,338,754, issued Jan. 15, 2002, the disclosure of which is incorporated by reference herein in its entirety. In another embodiment, the CPM material may comprise magnesium oxide. Of course, other materials may be used to form the CPM body 150 to accomplish the pressure transmission from the press to materials contained within the bore or opening 130 of the reaction cell. The CPM body 150 may also serve as a gasket material which is contacted by the anvils and flows between adjacent anvils in various applications. Further, the CPM body 150 may serve as an electrical and/or thermal insulator, insulating the anvils 116 from electrical current and/or high temperatures that are induced into the materials contained within the bore or opening 130.

As noted above, one or more cans (or canisters) 152 may be positioned in the opening 130 of the reaction cell 120. In the embodiment shown in FIG. 10, there are two cans 152 positioned end-to-end along an axis 154 that extends through the opening 130. In one embodiment, the cans 152 may be substantially cylindrical, with their longitudinal axis generally coinciding with, or substantially parallel to, the axis 154 extending through the opening 130. The cans 152 may include materials to be sintered or otherwise processed through a HTHP process via the press 100. For example, the cans may include diamond grains for formation of a polycrystalline diamond compact as previously noted. Some non-limiting examples of can assemblies and cell assemblies are set forth in U.S. Pat. No. 8,074,566, issued on Dec. 13, 2011, the disclosure of which is incorporated by reference herein in its entirety. Some non-limiting examples of diamond particle mixtures that may be used in forming a polycrystalline diamond compact are set forth in U.S. Pat. No. 8,616,306, issued Dec. 31, 2013, the disclosure of which is incorporated by reference herein in its entirety.

Packed immediately around the cans 152, in both the radial and axial directions, is a volume of first medium 156 which, in one embodiment, may include salt. The first medium 156 may be configured as a pressure transfer medium. In some embodiments, the first medium 156 may also be an insulative material. In other embodiments, the first medium 156 may be an electrically and/or thermally conductive material.

Radially adjacent to the first medium 156, and in one embodiment circumferentially surrounding the first medium 156, is a heating element 158. In one embodiment, the heating element 158 may be comprised of a graphite material. In one particular example, the heating element may include a flexible graphite material such as a Grafoil® material available from GrafTech International Holdings Inc. of Brooklyn Heights, Ohio. In one embodiment, the heating element 158 may be in direct contact with a portion of each can 152, such as with a lip 160 formed on each can that extends radially outward through first medium 156.

A second medium 162 surrounds the heating element 158 and may extend radially to or near the radial limits of the opening 130. The second medium 162 may be configured as a pressure transferring medium and an insulating medium. In one embodiment, the second medium may be comprised of salt and graphite. The second medium 162, as well as the first medium 156, also serves to redistribute hydraulic pressure applied by the press 100 via the anvils 116 and through CPM body 150 to more evenly distribute pressure to the cans 152.

A conductive disc 164 may be placed on each side of the cans 152, the discs providing a barrier within the opening 130 for the cans 152, the heating element 158 and adjacent materials. Each conductive disc 164 may be placed in direct contact with the heating element 158 as depicted in FIG. 10. In one embodiment, the discs 164 may be made of a metal or metal alloy (e.g., a metal or metal alloy comprising steel or titanium). Conductive rings 166 are placed at the ends of the opening 130 with one conductive ring 166 in direct contact with one of the conductive discs 164 and the other conductive ring 166 being in contact with the other conductive disc 164. In one embodiment, the rings 166 may be made of a metal or metal alloy(e.g., a metal or metal alloy comprising steel or titanium). The conductive rings 166 may extend axially to an associated face of the reaction cell 120 through which the opening 130 extends. In one embodiment, a third medium 168 may be placed within the conductive ring 166 and/or surround the conductive ring 166 to fill the remaining volume of the opening 130. In one embodiment, the third medium 168 may comprise a gasket material similar to that of the CPM body 150.

The reaction cell 120 is configured such that the twelve anvils 116 of the press 100 substantially simultaneously converge and advance on the twelve faces of the dodecahedral reaction cell 120 to apply or create substantially even pressure on all sides of the reaction cell 120. Additionally, as noted above, two of the anvils 116 may be conductive, providing electrical energy (current/voltage) to the reaction cell 120. More specifically, the anvils 116 which contact the faces of the reaction cell through which the opening 130 extends may be conductive, with those particular anvils physically and electrically contacting the conductive rings 166. Electric current, therefore, may flow from one anvil 116, through a conductive ring 166, through a conductive disc 164, through the heating element 158, through the other conductive disc 164, through the other conductive ring 166 and to the second conductive anvil 116. The various components may be in physical and electrical contact with each other (e.g., the anvils 116 with the conductive rings 166, the conductive rings 166 with the conductive discs 164, and conductive discs 164 with the heating element 158). Additionally, in the embodiment shown, the heating element 158 is in physical and electrical contact with cans 152 which may also be formed of a conductive material such as a metal or metal alloy. Thus, as current is applied via the two opposing anvils 116, the current results in resistive heating of the heater (and, thus, the cans 152) while pressure may be simultaneously applied via all the anvils 116 to the reaction cell 120.

In other embodiments, the heating element 158 may not be in physical contact with the cans 152. Thus, the heating element 158 may heat due to its electrical resistance to the current passing therethrough and heat the cans 152 via a thermally (and/or electrically) conductive first medium 156.

While the reaction cell 120 shown and described with respect to FIG. 10 includes two cans 152, the reaction cell may be configured to contain a different number of cans, including more than two cans or a single can. Additionally, by using a dodecahedral shaped reaction cell 120, there is sufficient volume in the CPM body 150 to accommodate a variety of types and sizes of cans while still ensuring substantially even distribution of pressure to the cans contained therein.

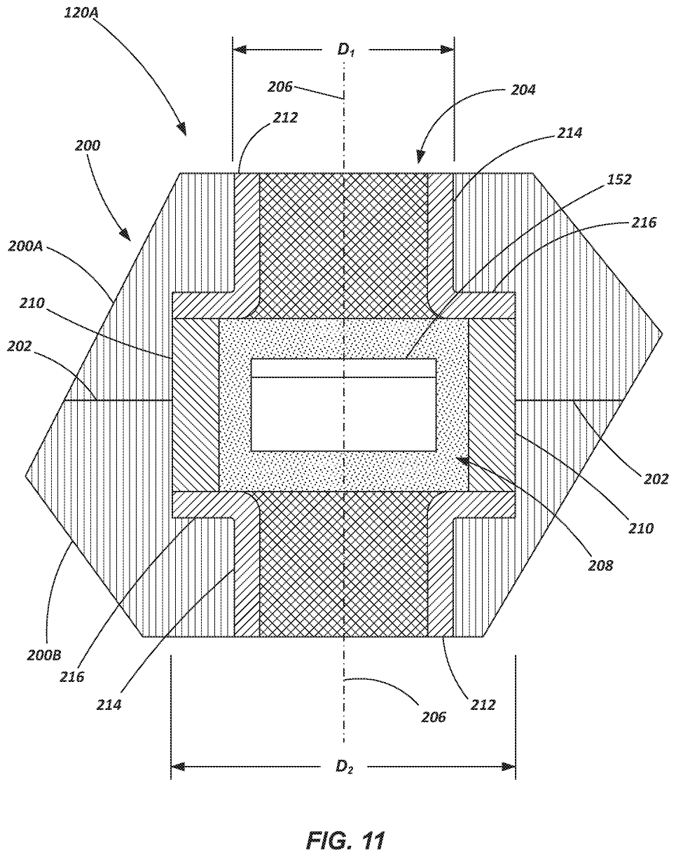

Referring to FIG. 11, another reaction cell 120A is shown in accordance with another embodiment of the disclosure. The reaction cell 120A includes many components similar to that of reaction cell 120 depicted in FIG. 10 and, thus, similar reference numbers are used to denote similar, though not necessarily identical, components of the reaction cell 120A.

The reaction cell 120A may include a body 200 comprising a CPM material such as, for example, a synthetic gasket material or other materials such as described above. The CPM body 200 may be split into two discrete components or halves 200A and 200B. For example, CPM body 200 may be split along a cut line 202 which defines mating surfaces of the two halves 200A and 200B such that the two halves 200A and 200B are removable or separable from each other. It is noted that the use of the term “halves,” as used herein, means that both portions of the body 200 may be unequal or may be equal in terms of volume or weight. Nor does the term “halves” mean that the geometry of such halves is limited (e.g., that the two halves symmetrical or unsymmetrical components).

With the two halves 200A and 200B positioned together into a single body 200 as shown in FIG. 11, an opening 204 may be formed collectively in the body 200 to extend through both halves 200A and 200B (e.g., a through-bore or through-hole extending from one face of the reaction cell 120A to an opposing face of the reaction cell 120A). As shown in FIG. 11, this opening 204 may be configured to exhibit a varying cross-sectional dimension along its axis 206. For example, the opening may exhibit a first diameter (D₁) at locations where it extends through the external faces of the reaction cell 120A while exhibiting a second diameter (D₂) at locations adjacent the cut line 202, wherein the first diameter D₁ is smaller than the second diameter (D₂). The enlarged opening or cavity in the center portion of the reaction cell 120A may be advantageous in accommodating larger cans 152, arranging multiple cans 152 in different spatial geometries, and/or in designing and assembling the various materials contained within the opening 204. In yet other embodiments, the opening may include multiple diameters (e.g., 3, 4, 5, etc.) of varying magnitudes or may exhibit a tapered geometry with a diameter that changes as a function of position along its axis.

A single can 152 or canister may be positioned in the opening 204 of the reaction cell 120A. In one embodiment, the can 152 may be substantially cylindrical, with its longitudinal axis generally coinciding with, or substantially parallel to, an axis 206 extending through the opening 204. The can 152 may include materials to be sintered or otherwise processed through a HTHP process via the press 100. For example, the can 152 may include diamond grains for formation of a polycrystalline diamond compact as previously noted.

As shown in FIG. 11, a volume of first medium 208 may be positioned immediately around the can 152, in both the radial and axial directions, which, in one embodiment, may include a salt material. The first medium 208 may be configured as a pressure transfer medium. In some embodiments, the first medium 208 may be an electrically and/or thermally conductive material.

In one embodiment, the first medium 208 is circumferentially surrounded by a heating element 210. As with the previously described heating element 158, the heating element 210 may comprise a graphite material including, but not limited to, a flexible and/or laminar graphite materials. Non limiting examples of flexible graphite materials include the commercially available Grafoil® products. In some embodiments, the heating element 210 may be in direct contact with a portion of the can 152. In other embodiments, the can 152 may be physically separated from the heating element via the first medium 208 such as shown in FIG. 11.

As shown in FIG. 11, conductive rings 212 may be positioned near the ends of the opening 204 with each conductive ring 210 being in direct contact with the heating element 210. In one embodiment, the rings 210 may comprise of a metal or metal alloy(e.g., a metal or metal alloy comprising steel or titanium). The conductive rings 210 may extend axially to or beyond an associated face of the reaction cell 120 through which the opening 204 extends. In one embodiment, the conductive rings 212 may include a body having a first, substantially cylindrical portion 214 and a second, flange portion 216. The flange portion 216 may be in contact with the heating element 210 while the cylindrical portion 214 may be configured to engage anvils 116 at their respective faces of the dodecahedral reaction cell 120A.

In one embodiment, a second medium 218 may be placed within each conductive ring 212 to fill the remaining volume of the opening 204. In one embodiment, the third medium 168 may comprise a gasket material similar to that of the CPM body 200.

The reaction cell 120A is configured such that the twelve anvils 116 of the press 100 converge (e.g., substantially simultaneously) on the twelve faces of the dodecahedral reaction cell 120A to apply pressure (e.g., substantially evenly) on all sides of the reaction cell 120A. Additionally, as noted above, two of the anvils 116 may be conductive, providing a selected level of electrical energy (e.g., a selected level of current and/or voltage) to the reaction cell 120A during the process. More specifically, in one embodiment, the anvils 116 which contact the faces of the reaction cell 120A through which the opening 204 extends may be conductive, with those particular anvils physically and electrically contacting the conductive rings 212. Current, therefore, may flow from one anvil 116, through a conductive ring 212, through the heating element 210, through the other conductive ring 212 and to the second conductive anvil 116. As shown in FIG. 11, the various components may be in physical and electrical contact with each other (e.g., the anvils 116 with the conductive rings 212, the conductive rings 212 with the heating element 210). Thus, for example, as current is applied via the two opposing anvils 116, the current results in resistive heating of the heating element, which is thermally transferred to the can 152, while pressure is simultaneously applied via all the anvils 116 to the reaction cell 120A.

The use of a split reaction cell 120A provides various advantages for certain applications, including the ability to adapt the reaction cell 120A for larger cans 152 or differently shaped cans. The split configuration also enables the use of different components (e.g., the conductive rings 212, which may be installed from the inside of the body 200 before the two halves are assembled) and provide ease of assembly and processing of the reaction cell 120A.

In addition to the various advantages of a dodecahedral press 100 and dodecahedral reaction cell 120 (and 120A) such as described herein, the dodecahedral press may be used to press reaction cells exhibiting other geometries (e.g., a reaction cell having an icosahedral geometry) including second stage pressing of such reaction cells.

While the disclosed embodiments may be susceptible to various modifications and alternative forms, specific embodiments have been shown by way of example in the drawings and have been described in detail herein. It should be understood that the invention is not intended to be limited to the particular forms disclosed. Additionally, elements, components or aspects of one embodiment described herein may be combined with elements, components or aspects of other described embodiments without limitation. The disclosed embodiments are deemed to include all modifications, equivalents, and alternatives falling within the spirit and scope of the invention as will be recognized and appreciated by those of ordinary skill in the art.

1. A high-temperature, high-pressure (HTHP) press comprising:
a plurality of press bases arranged in an icosahedral geometry;
wherein:
each press base includes a body portion housing a piston, the piston being displaceable toward a central region of the press;
each press base includes an anvil coupled with the piston;
each anvil includes an engagement surface and a side surface, wherein each anvil is displaceable along an associated centerline relative to a center region associated with an intersection of the centerlines; and
when each of two adjacent anvils of the plurality of anvils is displaced along the associated centerline thereof at a rate of \dot{x}, the side surfaces of each of the two adjacent anvils are displaced towards each other at a rate of ġ, and wherein the ratio of ġ/\dot{x} is 0.357.

2. (canceled)

3. (canceled)

4. The press of claim 1, wherein the engagement surface of each anvil includes a substantially planar face having a periphery exhibiting one of a triangular, a rectangular, a hexagonal, or a pentagonal geometry.

5. The press of claim 1, wherein at least two of the anvils are coupled with a source of electrical energy.

6. The press of claim 1, further comprising a reaction cell disposed in a central region of the press, wherein each of the anvils is in contact with a separate face of the reaction cell.

7. The press of claim 6, wherein the reaction cell includes a through hole extending from a first face of the reaction cell to a second face of the reaction cell.

8. The press of claim 7, wherein the reaction cell includes a heating element and at least one canister containing a sinterable material.

9. The press of claim 6, wherein the reaction cell comprises two mating halves assembled together.

10. The press of claim 1, further comprising a plurality of tie bars, wherein each tie bar extends between, and is coupled to, a pair of adjacent bases.

11. A reaction cell for use in a high-temperature, high pressure (HTHP) press, the reaction cell comprising:
a body exhibiting one of an octahedral, a dodecahedral or an icosahedral geometry, the body including a through hole extending from a first face to a second face of the body.

12. The reaction cell of claim 11, further comprising at least one canister disposed within the through-hole, the at least one canister containing a sinterable material.

13. The reaction cell of claim 12, further comprising a heating element disposed within the through-hole and adjacent the at least one canister.

14. The reaction cell of claim 11, wherein the through hole includes first section exhibiting a first diameter and a second section exhibiting a second diameter.

15. A high-pressure, high-temperature (HTHP) press comprising:
a plurality of anvils, wherein each anvil includes an engagement surface and a side surface, and wherein each anvil is displaceable along an associated centerline relative to a center region associated with an intersection of the centerlines;
wherein, when each of two adjacent anvils of the plurality of anvils is displaced along its associated centerlines at a rate of \dot{x}, the side surfaces of each of the two adjacent anvils are displaced towards each other at a rate of ġ, and wherein the ratio of ġ/\dot{x} is 0.357 or less.

16. (canceled)

17. (canceled)

18. (canceled)

19. The press of claim 15, further comprising a plurality of bases, each base being associated with one of the plurality of anvils and configured to displace the associated anvil along its associated centerline.

20. (canceled)

21. (canceled)

22. The press of claim 15, wherein the plurality of anvils includes at least 20 anvils arranged in an icosahedral geometry.

23. (canceled)

24. (canceled)

25. (canceled)
